(19) United States
(12) Patent Application Publication
(10) Pub. No.: US 2026/0298577 A1
(43) Pub. Date: Oct. 1, 2026

(54) AUTOMATED SYSTEM FOR CLEANING AND INSPECTION OF STRAIGHT HOLLOW CYLINDRICAL OBJECTS

(71) Applicant: Griffyn Robotech Pvt. Ltd., Pimpri Chinchwad (IN)

(72) Inventors: Amit Anil Mahajan, Cumming, GA (US); Samir Shriram Bagalkote, Pune (IN); Rohit Kishor Bibate, Pune (IN); Ajay Vaishnav, Udaipur (IN)

(73) Assignee: Griffyn Robotech Pvt. Ltd., Pimpri Chinchwad (IN)

(21) Appl. No.: 19/569,599

(22) Filed: Mar. 17, 2026

(30) Foreign Application Priority Data
Mar. 25, 2025 (IN) IN202523027749A
Mar. 25, 2025 (IN) IN202523027751A

(51) Int. Cl. F41A 29/00; A46B 5/00; A46B 13/04; A46B 15/00; F41A 31/02; H04N 23/698; H04N 23/90

(52) U.S. Cl. CPC F41A 29/00; A46B 5/0012; A46B 13/04; A46B 15/0004; F41A 31/02; H04N 23/698; A46B 2200/3013; H04N 23/90

(57) ABSTRACT

A system for cleaning and inspecting straight hollow cylindrical objects. The system includes a robotic cleaning and inspection device connected to a main controller unit. The device includes a vision system for capturing 360° view images and real time video footage of the inner wall of the straight hollow cylindrical object. The vision system comprises: at least one image sensing device, a linear distance sensor measuring a distance between the vision system and an end of the straight hollow cylindrical object, an angular sensor measuring an angular orientation of the vision system. The vision system includes an image processing module configured to receive data from the at least one image sensing device, linear distance sensor, and angular sensor, and configured to process the received data into a single image depicting a 360° view of the inner wall of the straight hollow cylindrical object.

This application claims the benefit of priority under 35 U.S.C. § 119(a) to Indian Patent Application No. IN202523027749A, filed on Mar. 25, 2025, titled “Rotary Camera Based Inspection Unit for Automated Cleaning System for Straight Hollow Cylindrical Objects,” and to Indian Patent Application No. IN202523027751A, filed on Mar. 25, 2025, titled “Multi Camera Based Inspection Unit for Automated Cleaning System for Straight Hollow Cylindrical Objects.” This application is also related to European Patent Application No. EP26165524.5, titled “An Automated System for Cleaning and Inspection of Straight Hollow Cylindrical Objects” filed on Mar. 17, 2026. The entire contents of each of the foregoing applications are hereby incorporated by reference in their entirety.

### FIELD OF THE INVENTION

The present subject matter relates generally to the field of cleaning and inspection devices, and more specifically, to an automated cleaning and vision inspection of straight hollow cylindrical objects, preferably an internal bore surface of large caliber gun barrels.

### BACKGROUND OF THE INVENTION

Large caliber guns are the weapon of choice in the modern battlefield due to their long firing range and increasing accuracy. These are the main ordnance systems used in modern artillery and tanks built to launch munitions far beyond the range and power of infantry firearms. A variety of guns systems come under large caliber category, from 76 caliber to 155 caliber artillery and tank guns to variety of mortar and Naval Guns.

For each round fired by this weapon, the gun barrel is subjected to high pressure, temperature, shocks, and friction along with corrosive mixture of gasses and residue generated post combustion of propellants which causes wear and erosion of the gun barrel's internal surface.

The wear and erosion are examples of several failure mechanisms that affect the operational effectiveness and life of large caliber gun barrels. Firing of ammunition from a gun barrel leads to a lot of undesirable residues of burnt propellants, carbon, copper, inside the barrel that react easily with the metal surfaces inside gun barrel. This process can be accelerated by the high inner temperature of the gun barrel that typically exists after firing. All this leads to accelerating the rate of the wear and erosion of the barrel's internal surface if not cleaned regularly. In order to limit the erosion of a gun barrel under normal firing conditions the gun barrels require regular and effective cleaning to ensure maximum performance and operational readiness.

Although a lot of efforts have been put into development and modernization of gun systems, relatively the cleaning of the gun barrels is still an under explored area. Cleaning the long barrel of large caliber gun is one of the critical tasks that a soldier has to perform along with other mission critical tasks on the field.

Currently, in most of the cases, the barrel cleaning is done manually using a brush attached to a long cleaning rod. The main steps used in a manual cleaning operation are to soak the brush with a cleaning solution, insert the cleaning rod into the bore of a barrel, and clean the barrel with repeated forward-backward action. After cleaning with multiple cleaning cycles, the bore must be mopped using the same rod with a new cleaning cloth wound on the brush to remove loose sludge and sediments and then lubricated using a fresh cloth soaked in the lubricant oil. Further it should be wiped using another clean cloth to remove excess lubricant. This operation takes hours to clean, mop, lubricate and wipe the gun barrel before it is ready for action.

The manual cleaning involves multiple individuals simultaneously repeating the horizontal forward & backward movement of a cleaning rod at approximately their shoulder height for a long period of time. Such a posture is difficult to maintain from an ergonomic point of view. Moreover, manual cleaning is not effective, as simple pushing of the cleaning rod without spiral movement results in uneven contact between the cleaning brush and the gun barrel surface which cannot remove sludge especially in case of riffled barrel grooves. Also, due to limited visibility of manual inspection by bare eyes, it is difficult to judge if the surface is cleaned or not or requires additional cleaning. Thus, a manual cleaning method is inconsistent, irreproducible, highly laborious, time consuming and subjective in nature.

Various methods are disclosed in the prior art that describe semi-automatic and automatic motorized cleaning devices to solve the above-mentioned problems associated with manual cleaning of gun barrels. Many of such devices comprise an electrically or pneumatically powered rotating and reciprocating brush along with spraying of cleaning agent followed by mopping, lubrication and wiping the gun barrel. Each cleaning step is carried out by intermittently removing the device out of the barrel and replacing the new cleaning cloth after each cleaning cycle. In a few cases, it is also required to replace the brush heads and wipes in a single cleaning operation in order to get the desired cleaning results. So, although the device cleaning functions are automated, there requires manual intervention to take the cleaning device out of the gun barrel and replace either brushes or cleaning cloths intermittently during cleaning operations, thus the operation may not be considered fully automatic. The other limitation for the existing cleaning devices is that they are suitable only for specific caliber barrels. The cleaning solution used to loosen out the residues and sludges may react with barrel material and can cause pitting and erosion if exposed for a long time. Excessive use of cleaning solutions and excessive lubricants may have an adverse effect on the bore surface. So, optimized use of these chemicals is one of the crucial requirements.

Moreover, to assess the quality of cleaning, a few methods described in the prior art utilize a camera attached to the cleaning device to view the cleaned surface. The currently available solutions for gun barrel inspection are mostly manual operations based on mirror reflection of the inner surface of the gun barrel. The exact angular position of the defect in the barrel is measured manually with gauges. The position of the defect detected in the barrel is hard to localize in terms of both distance and angle from the global reference. In few prior art applications, the operator can view the real-time video or images of the barrel surface and can judge the cleaning performance. In case any uncleaned area is observed, the operator can decide to repeat the cleaning operation. For this he can operate the device in manual mode in order to get the desired cleaning performance. Thus, although the camera is used to view the bore surface, it ends up with a camera assisted manual inspection only. The judgment of cleaning performance is based on operator's skills and experience and is quite subjective. Moreover, traceability of records of cleaning operation and associated data of before and after cleaning could be time consuming and error prone in case of manual data feeding. The data is taken either randomly or takes extra time to complete manually which becomes exhaustive for the personnel performing the operation. There is no digital storage for the future reference and the people on field do not have access to the inspection equipment.

Cleaning and inspection is a crucial aspect of maintenance activity of large caliber guns. Cleaning and inspection have to be performed before and after firing and also while the gun is not in use to keep the equipment ready for action during its useful service life.

Accordingly, there exists a need to provide a gun barrel inspection system that is improved in several ways such as automation of the process and precise localization and tagging of the defects. Along with the captured images, the precise data related to defects in the barrel, such as angle and distance from one end, linear as well as radial mapping of defects, automation with better data storage can help in easy and fast assessment of the required defect.

### OBJECTS OF THE INVENTION

An objective of one or more embodiments of the invention is to automate scrubbing, mopping, lubrication and wiping of the entire bore surface of a gun barrel without the need to remove the device out of the gun barrel during cleaning to replace the brush or mopping or wiping cloth.

Yet another objective of one or more embodiments of the invention is to optimize the use of cleaning solution and lubricants to limit the corrosive effect of cleaning solution and to prevent over lubrication.

Yet another objective of one or more embodiments of the invention is to provide quick and easy replacement of worn-out brush heads without the requirement of dismantling the device after prolonged use.

Yet another objective of one or more embodiments of invention is to provide quick and easy replacement of disposable mopping cloth after use.

Another objective of one or more embodiments of the invention is to scan the bore surface before and after cleaning to assess the cleaning performance.

Yet another objective of one or more embodiments of the invention is to localize an uncleaned patch, if any, after completion of a main cleaning cycle and to pass-on the coordinates of the location of the uncleaned patch in the barrel to a controller, which can then initiate a second cycle of cleaning on the uncleaned patch selectively.

Yet another objective of one or more embodiments of automatic inspection is to inspect the barrel bore surface as a safety assessment for detection, localization and measurement of any surface defects present on the bore surface, wherein the surface defects can be pits, erosion, wear, scratches, dents or cracks.

### SUMMARY OF THE INVENTION

According to a first aspect of the present disclosure, there is provided a system for cleaning and inspecting straight hollow cylindrical objects, the system comprising a robotic cleaning and inspection device connected to a main controller unit; the robotic cleaning and inspection device comprising:
a drive assembly for driving the cleaning and inspection device linearly along the length of the straight hollow cylindrical object while rotating it spirally on its longitudinal axis;
a spray nozzle assembly operably connected to the main controller unit, the spray nozzle assembly having outlet spray nozzles;
a vision system attached to the front end of the cleaning device and operably connected to the main controller unit, the vision system configured for capturing images and real time video footage of the inner wall of the straight hollow cylindrical object;
a scrubbing assembly, which includes a scrubbing brush and a reciprocating mechanism, wherein the reciprocating mechanism is configured to move the scrubbing brush forward and backward along the axis of the cleaning and inspection device; and
a mopping assembly located towards the front end of the cleaning and inspection device;
   wherein
the vision system is for capturing 360° view images and real time video footage of the inner wall of the straight hollow cylindrical object, and the vision system comprises:
   at least one image sensing device pointing towards the inner wall of the straight hollow cylindrical object when in use, a linear distance sensor for measuring a distance between the vision system and an end of the straight hollow cylindrical object when in use, an angular sensor (e.g. a gyroscope or rotary encoder) for measuring an angular orientation of the vision system about a longitudinal axis of the straight hollow cylindrical object when in use, relative to a predefined reference orientation within the straight hollow cylindrical object; and
   an image processing module, the image processing module configured to receive data from the at least one image sensing device, the linear distance sensor, and the angular sensor, and configured to process the received data into a single image depicting a 360° view of the inner wall of the straight hollow cylindrical object.

The drive assembly may be located at a mid-section of the cleaning and inspection device.

The scrubbing unit assembly may comprise:
a front scrubbing brush assembly, which includes a scrubbing brush and a reciprocating mechanism, wherein the reciprocating mechanism is configured to move the scrubbing brush forward and backward along the axis of the cleaning and inspection device; and
a rear scrubbing brush assembly, which includes a scrubbing brush and a reciprocating mechanism, wherein the reciprocating mechanism is configured to move the scrubbing brush forward and backward along the axis of the cleaning and inspection device;
wherein the front scrubbing brush assembly and the rear scrubbing brush assembly are located on opposite sides of the drive assembly.

The spray nozzle assembly may comprise:
a front spray nozzle assembly operably connected to the main controller unit; the front spray nozzle assembly having outlet spray nozzles, wherein the front spray nozzle assembly is attached next to the front scrubbing brush assembly; and
a rear spray nozzle assembly operably connected to the main controller unit; the rear spray nozzle assembly having outlet spray nozzles, wherein the rear spray nozzle assembly is located next to the rear scrubbing brush assembly.

The mopping assembly may be located next to the front scrubbing brush assembly.

The vision system may be attached next to the mopping assembly at the front end of the cleaning and inspection device.

The spray nozzle assembly may include a plurality of outlet spray nozzles mounted radially on a spray nozzle manifold.

The linear distance sensor may be secured at the front end of the vision system, such that it is configured to point towards a chamber end of the straight hollow cylindrical object when in use, and configured to detect the distance of the vision system from a reference point.

The mopping assembly may comprise a plurality of mopping brush units, which are configured to be radially opened or closed with respect to the axis of device.

The vision system may comprise a rotary camera module. The rotary camera module may comprise a stationary part and a rotary camera head, wherein the rotary camera head is rotatably coupled with the stationary part, and wherein the rotary camera head comprises the at least one image sensing device.

The vision system may comprise a multi camera module. The multi camera module may comprise a camera hub which is fitted with a plurality of image sensing devices that each point radially towards the inner wall of the straight hollow cylindrical object when in use.

According to a further aspect of the present disclosure, there is provided a method of using any system disclosed herein, the method comprising:
during one or more first passes of the cleaning and inspection device along a straight hollow cylindrical object: acquiring pre-cleaning images of the inner wall of the straight hollow cylindrical object using the vision system; and spraying cleaning liquid radially on the inner wall of the straight hollow cylindrical object using the spray nozzle assembly;
during one or more subsequent passes of the cleaning and inspection device along the straight hollow cylindrical object, activating the reciprocating mechanism of the scrubbing assembly to move the scrubbing brush forward and backward along the axis of the cleaning and inspection device to remove undesirable material from the inner wall of the hollow cylindrical object;
during one or more subsequent passes of the cleaning and inspection device along the straight hollow cylindrical object, radially expanding the mopping assembly such that a plurality of mopping brush units of the mopping assembly presses against the inner wall of the straight hollow cylindrical object; and
during a subsequent pass of the cleaning and inspection device along the straight hollow cylindrical object, acquiring post-cleaning images of the inner wall of the straight hollow cylindrical object using the vision system.

The method may further comprise:
spraying lubricant radially on the inner wall of the straight hollow cylindrical object using the spray nozzle assembly.

The method may further comprise:
processing the pre-cleaning images and the post-cleaning images of the inner wall of the straight hollow cylindrical object to assess cleaning performance using deep learning and image processing models.

The method may further comprise:
processing the pre-cleaning images and the post-cleaning images of the inner wall of the straight hollow cylindrical object to detect any uncleaned patches on the inner wall of the straight hollow cylindrical object and their associated coordinates; and
generating a further cleaning sequence for automatically controlling the cleaning and inspection device such that it cleans the detected uncleaned patches.

### BRIEF DESCRIPTION OF THE DRAWINGS

FIG. 1 is an illustration of general set-up of an automated gun barrel cleaning and inspection system, in accordance with an embodiment of the present invention;

FIG. 2 is a robotic cleaning and inspection device, in accordance with an embodiment of the present invention;

FIG. 3 is a cut section view of the robotic cleaning and inspection device, in accordance with an embodiment of the present invention;

FIG. 4 is a close-up view of a cleaning scrubbing brush assembly of the robotic inspection & cleaning device, in accordance with an embodiment of the present invention;

FIG. 5 is an illustration of a scrubbing mechanism of the robotic inspection & cleaning device in action, in accordance with an embodiment of the present invention;

FIG. 6 is a closer view of a spray nozzle assembly of the robotic cleaning and inspection device, in accordance with an embodiment of the present invention;

FIG. 7 is a close-up view of an encoder assembly of the robotic cleaning and inspection device, in accordance with an embodiment of the present invention;

FIG. 8 is an illustration of a mopping brush assembly indicating brush mount and brush head, in accordance with an embodiment of the present invention;

FIG. 9 is an exploded view of a mopping brush assembly indicating brush mount and brush head, in accordance with an embodiment of the present invention;

FIG. 10 is a closer view of a mopping brush assembly with easy detachable mopping cloth cap, of a robotic cleaning and inspection device in accordance with an embodiment of the present invention;

FIG. 11 is a closer view of a rotary camera module of the robotic cleaning and inspection device, in accordance with an embodiment of the present invention;

FIG. 12 is a closer view of a multi-camera module of the robotic cleaning and inspection device, in accordance with an embodiment of the present invention;

FIG. 13 is a general construction of a Pump Unit as a part of an automated gun barrel cleaning and inspection system, in accordance with an embodiment of the present invention;

FIG. 14 is a system architecture block diagram of the automated gun barrel cleaning and inspection system, in accordance with an embodiment of the present invention;

FIG. 15 is a process flow the automated gun barrel cleaning and inspection system, in accordance with an embodiment of the present invention;

FIG. 16 shows a graphical user interface of the main controller display in accordance with an embodiment of the present invention;

FIG. 17 shows images depicting a raw image of a gun barrel internal surface, unclean patches detection and localization and selective auto-cleaning of the same section of gun barrel, in accordance with an embodiment of the present invention.

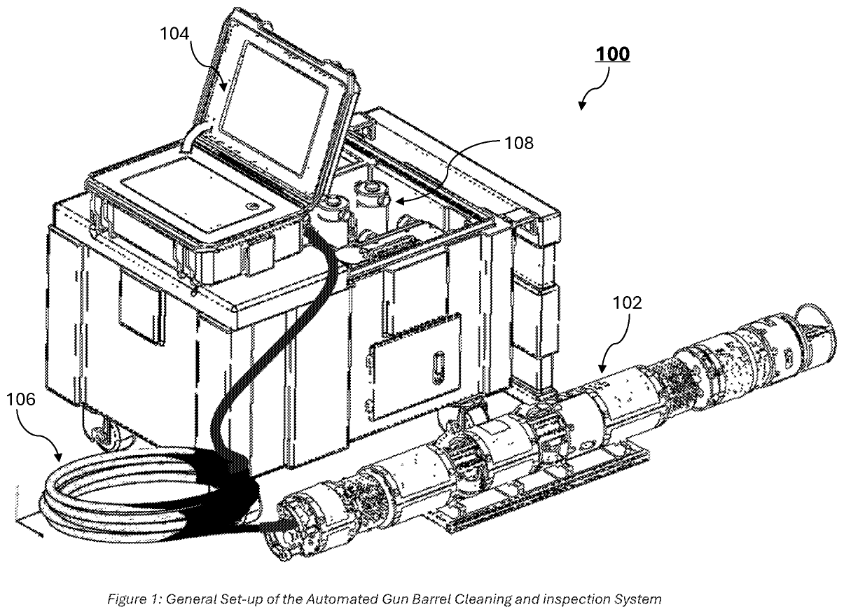

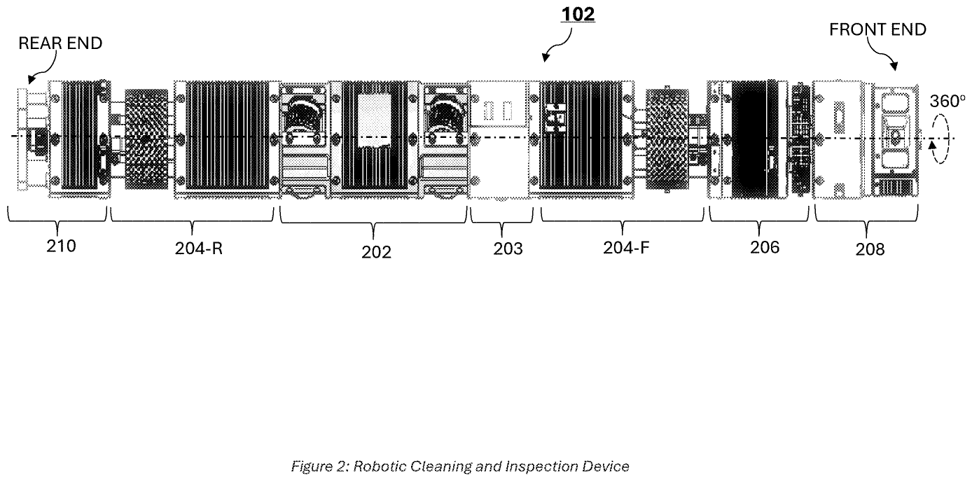

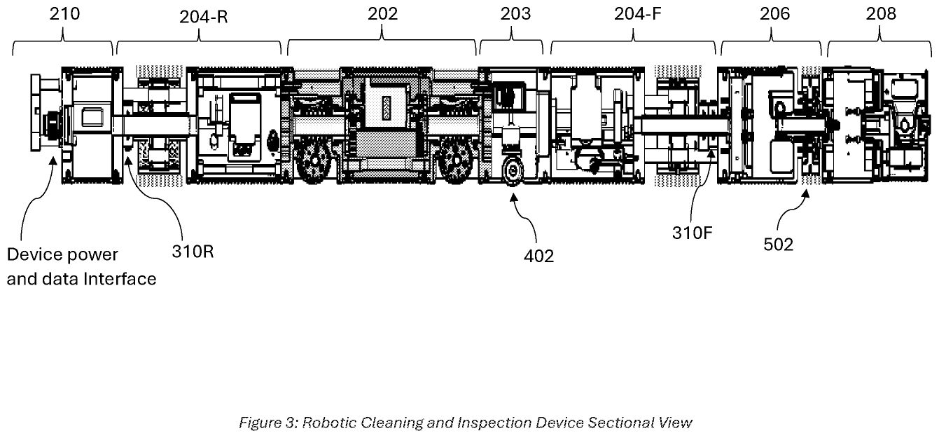

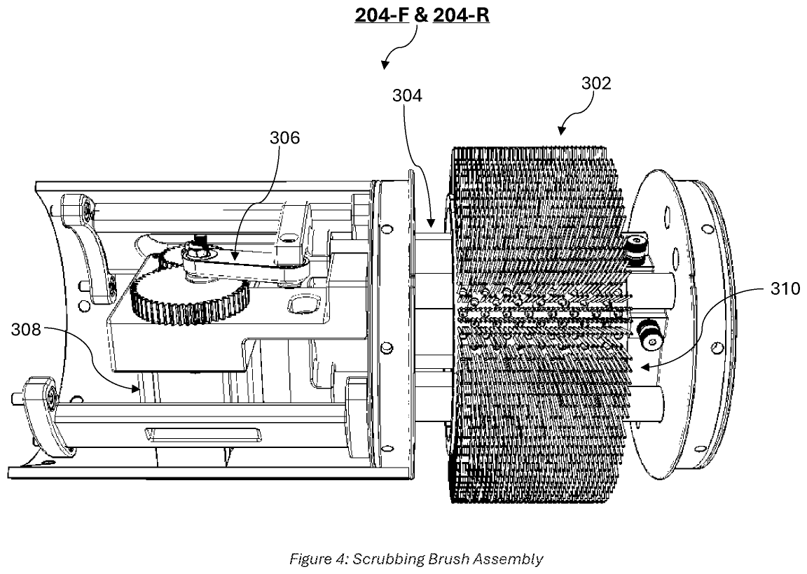

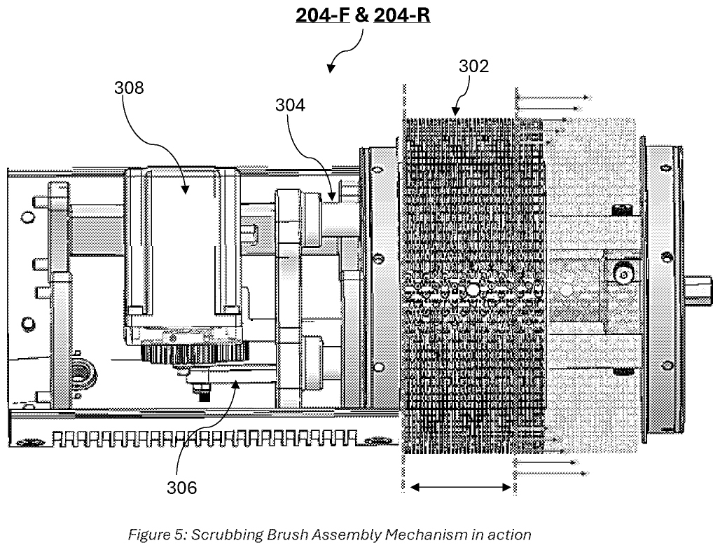

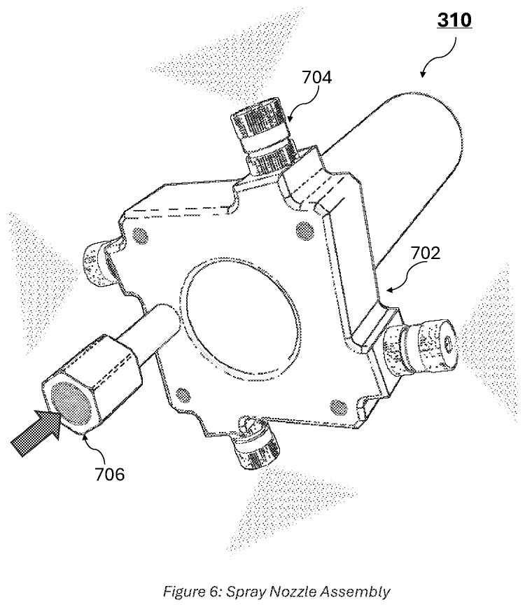

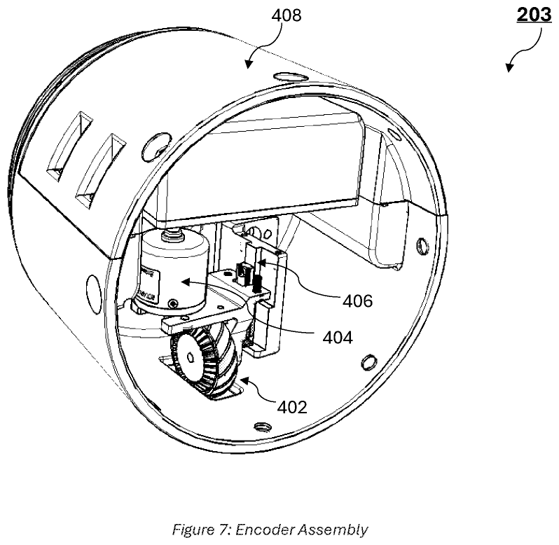

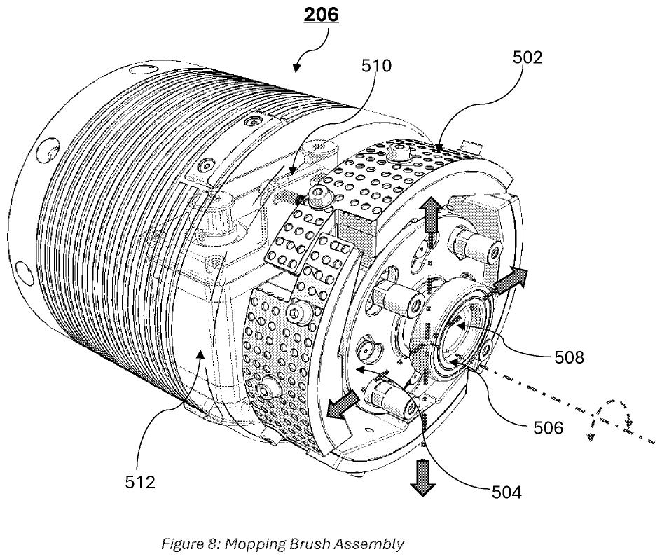

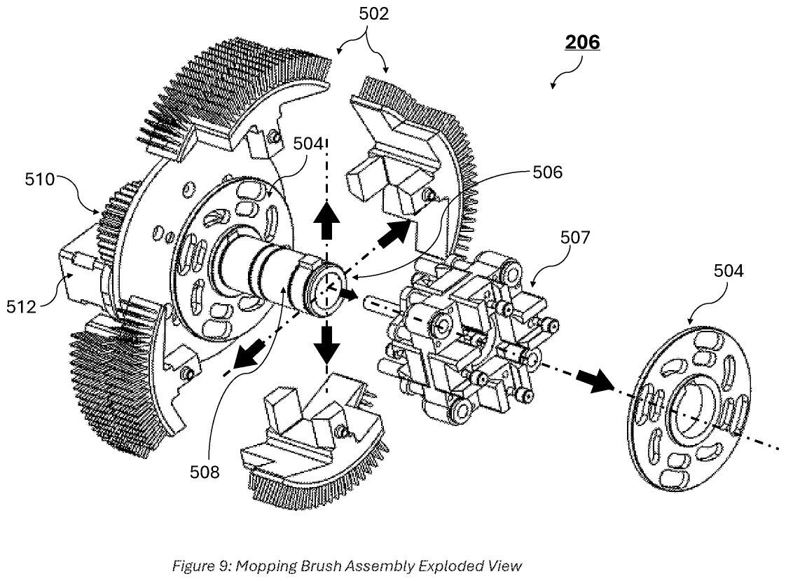

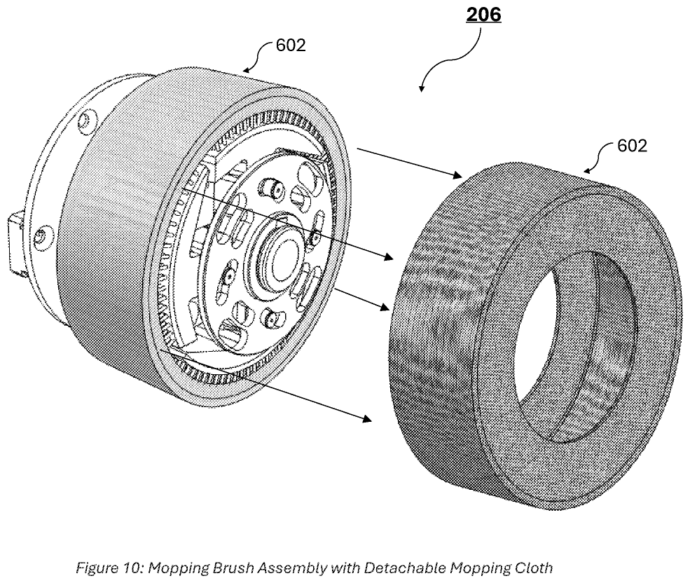

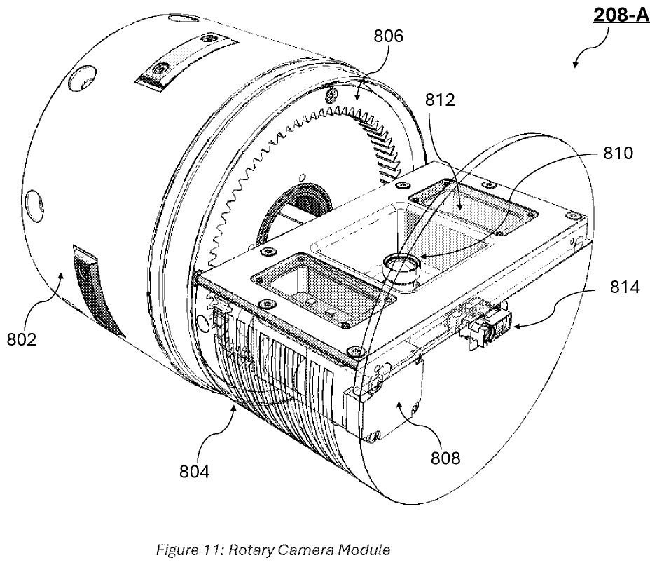

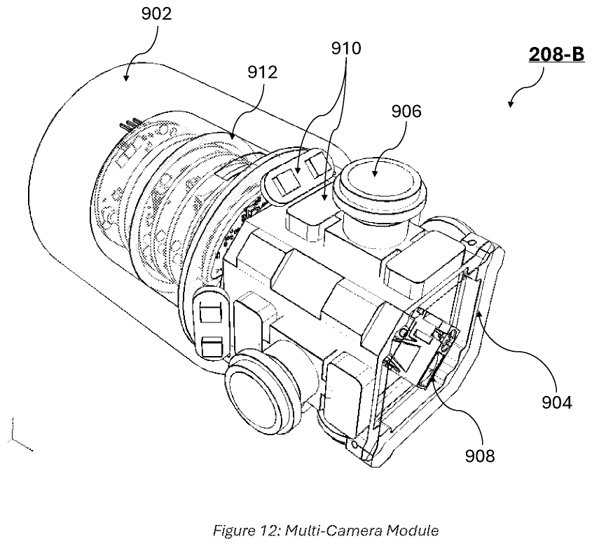

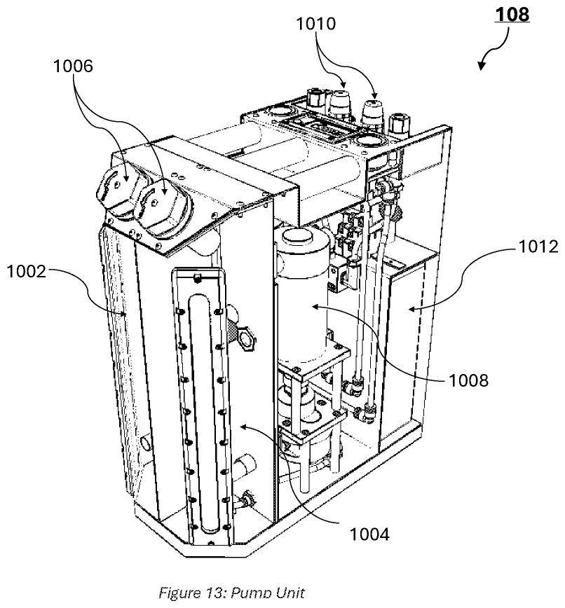

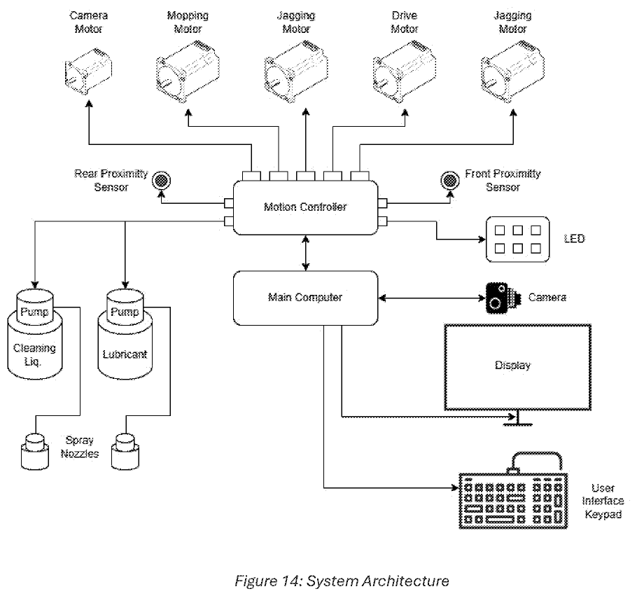

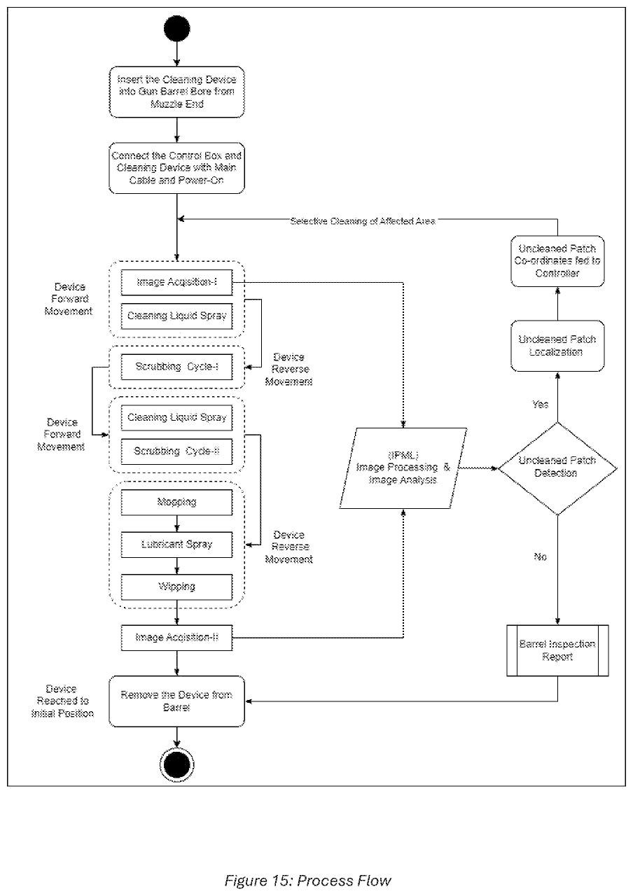

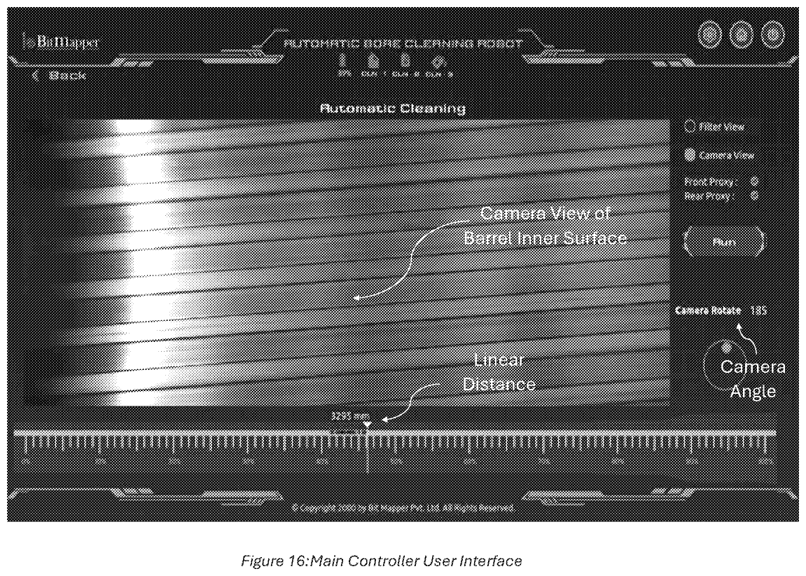

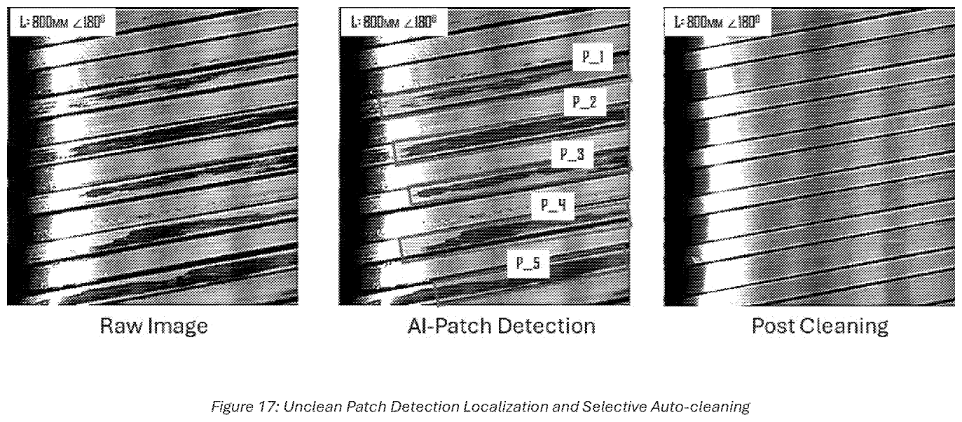

| Figure # | Description |
|---|---|
| FIG. 1 | General Set-up of the Automated Gun Barrel Cleaning and |
| | inspection System |
| FIG. 2 | Robotic Cleaning and Inspection Device |
| FIG. 3 | Robotic Cleaning and Inspection Device Sectional View |
| FIG. 4 | Scrubbing Brush Assembly |
| FIG. 5 | Scrubbing Brush Assembly Mechanism |
| FIG. 6 | Spray Nozzle Assembly |
| FIG. 7 | Encoder Assembly |
| FIG. 8 | Mopping Brush Assembly |
| FIG. 9 | Mopping Brush Assembly Exploded View |
| FIG. 10 | Mopping Brush Assembly with Detachable Mopping Cloth |
| FIG. 11 | Rotary Camera Module |
| FIG. 12 | Multi-Camera Module |
| FIG. 13 | Pump Unit |
| FIG. 14 | System Architecture |
| FIG. 15 | Process Flow |
| FIG. 16 | Main Controller User Interface |
| FIG. 17 | Unclean Patch Detection Localization and Selective Auto- |
| | cleaning |

### DETAILED DESCRIPTION OF THE EMBODIMENTS

One or more of the foregoing objects of the invention are accomplished and the problems and shortcomings associated with prior art techniques and approaches are overcome by the present invention described in the present embodiments.

In order to solve the problems depicted in the background and to provide technological solutions for the limitation in prior arts a new smart inspection and cleaning device is proposed. In one of the embodiments of the present disclosure, is an automated gun barrel cleaning and inspection system that comprises a robotic cleaning and inspection device connected to a main controller unit with a main control cable. The robotic cleaning and inspection device is essentially a cylindrically shaped vehicle body comprising a main drive assembly located at the mid-section of the said device, a front and rear scrubbing brush assembly located at each side of the main drive assembly, an encoder assembly connected between the drive assembly and front scrubbing brush assembly, a spray nozzle assembly attached next to each of the scrubbing brush assemblies, a mopping brush assembly located next to the front scrubbing brush assembly, a camera module attached at the end of mopping brush assembly and an Interface unit for power and data interface of robotic cleaning and inspection device to the main control unit via a main control cable.

As described above in the background, the gun barrel bore cleaning involves a wet scrubbing to dislodge the combustion residue, carbon and other contaminants adhered to bore inner surface, mopping of the loose sludge, and lubrication of the gun barrel by applying gun lubricant oil on a cleaned barrel surface in order to protect the barrels bore surface from corrosion.

The foregoing detailed description of embodiments is better understood when read in conjunction with the appended drawings. For the purpose of illustrating the disclosure, there is shown in the present document example constructions of the disclosure; however, the disclosure is not limited to the specific system/apparatus or method disclosed in the document and the drawings.

The present disclosure is described in detail with reference to the accompanying figures. In the figures, the left-most digit(s) of a reference number identifies the figure in which the reference number first appears. The same numbers are used throughout the drawings to refer various features of the present subject matter.

In the above accompanying drawings, an underlined number relates to an item identified by a line linking the non-underlined number to the item. When a number is non-underlined and accompanied by an associated arrow, the non-underlined number is used to identify a general item at which the arrow is pointing.

Further, the figures depict various embodiments of the present subject matter for purposes of illustration only. One skilled in art will readily recognize from the following discussion that alternative embodiments of the structures and methods illustrated herein may be employed without departing from the principles of the present subject matter described herein.

The reference numbers in the accompanying drawings and the corresponding component are listed in the Table below:

TABLE
List of Numbering Labels

| Reference# | | Description |
|---|---|---|
| 100 | Automated gun barrel cleaning and Inspection system Set-up | |
| | 102 | Robotic Cleaning and Inspection Device |
| | 104 | Main Controller |
| | 106 | Main Cable Harness |
| | 108 | Pump Unit |
| 102 | Robotic Cleaning and Inspection Device | |
| | 202 | Main Drive Assembly |
| | 203 | Encoder Assembly |
| | 204-F | Scrubbing Brush Assembly- Front |
| | 204-R | Scrubbing Brush Assembly- Rear |
| | 206 | Mopping Brush Assembly |
| | 208 | Camera Module |
| | 210 | Interface Unit |
| | 310 | Spray Unit Assembly |
| 204F & | Front and Rear Scrubbing Brush Assemblies | |
| 204-R | 302 | Scrubbing Brush Segments |
| | 304 | Guide Rods |
| | 306 | Jagging Mechanism Assembly |
| | 308 | Motor |
| | 310 | Spray Unit Assembly |
| 310 | Spray Unit Assembly | |
| | 702 | Spray Unit Manifold |
| | 704 | Spray Nozzles |
| | 706 | Inlet Valve |
| 203 | Encoder Assembly | |
| | 402 | Rotary Wheel |
| | 404 | Rotary Encoder |
| | 406 | Spring Loaded Guide Assembly |
| | 408 | Encoder Unit Enclosure |
| 206 | Mopping Brush Assembly | |
| | 502 | Brush Segments |
| | 504 | Slotted Cam |
| | 506 | Support Bearings |
| | 507 | Brush Segment Mounting Hub |
| | 508 | Central Shaft |
| | 510 | Mopping Mechanism Assembly |
| | 512 | Motor |
| | 602 | Detachable Mopping Cloth |
| 208 | Camera Based Vision System | |
| 208-A | Rotary Camera Module | |
| | 802 | Stationary Part |
| | 804 | Rotary Camera Head |
| | 806 | Rotary Gear Mechanism |
| | 808 | Rotary Camera Head Motor |
| | 810 | Camera |
| | 812 | LEDS |
| | 814 | Laser Distance Sensor |
| 208-B | Multi Camera Module | |
| | 902 | Multi-Camera Module Enclosure |
| | 904 | Multi-Camera Hub |
| | 906 | Cameras |
| | 908 | LEDs |
| | 910 | Laser Distance Sensor |
| 108 | Pump Unit | |
| | 1002 | Cleaning Liquid Reservoir |
| | 1004 | Lubricant Oil Reservoir |
| | 1006 | Inlet Ports for Cleaning Liquid and Lubricant Oil |
| | 1008 | Pump & Motor Assembly |
| | 1010 | Outlet Ports for Cleaning Liquid and Lubricant Oil |
| | 1012 | Battery Unit |

Referring to the FIGS. 1 to 17, an automated system 100 for cleaning and inspection of hollow cylindrical objects, such as a gun barrel, is shown in accordance with the present claimed subject matter.

In an embodiment, the system 100 comprises a robotic cleaning and inspection device 102 connected to a main controller unit 104 via a main cable harness 106, and an integrated pump unit 108 for dispensing cleaning fluid and lubricant oil. Now the robotic cleaning and inspection device 102 will be described in detail with the help of figures.

Now referring to FIGS. 2 and 3, the robotic cleaning and inspection device 102, hereinafter referred as “the device 102”, is essentially a cylindrically shaped vehicle body comprising a main drive assembly 202 located at the mid-section of the said device 102, a front and rear scrubbing brush assembly 204F and 204R located at each side of the main drive assembly 202, an encoder assembly 203 connected in between a drive wheel assembly 202 and the front scrubbing brush assembly 204F, a spray nozzle assembly 310F and 310R is attached next to each front and rear scrubbing brush assemblies 204F and 204R respectively, a mopping brush assembly 206 located next to the front scrubbing brush assembly 204F and a camera module 208 attached next to mopping brush assembly 206 at the front end of the device 102. A controller interface unit 210 is attached next to rear scrubbing brush assembly at rear end of the device 102.

The main drive assembly 202 as shown in FIGS. 2 and 3, can essentially be any locomotion arrangement to drive the device 102 inside the bore of a gun barrel. The main drive assembly 202 can be a wheel assembly driven by electrical motor directly or with a combination of gear train or belt drive or any suitable arrangement known in the art.

The description provided hereafter for the drive assembly 202 is just for the embodiment purposes only. In the current embodiment, the drive assembly 202 comprises a worm gear and worm wheel gear arrangement, wherein a plurality of worm wheel gears radially spaced apart in equal intervals are engaged on a hollow shaft worm gear. The hollow shaft worm gear is mounted into the main drive assembly 202 concentrically with device 102. The plurality of wheels is coupled to each worm wheel gear and can be rolled by the rotation force transferred from the worm gear. The worm gear is rotated by means of reduction gears driven by an electrical motor. The wheels protrude out radially a little from the outer casing of the main drive assembly 202 and are arranged in such a way that the outer rim of the wheels is in contact with the inner wall of the gun barrel in case of a smooth bore gun barrel or in case of riffled bore it may be engaged in the grooves of a riffled bore barrel. In both the cases, the angle of wheels is kept in such a way that the device 102 displaces/moves linearly along the length of barrel while it rotates spirally on its own longitudinal axis, wherein the angle of twist is adjusted to the length of the barrel in case of a smooth bore and it matches the angle of twist of the riffling in case of a riffled barrel while engaged into the grooves.

Now the following section will describe construction and working of the scrubbing brush assembly 204F and 204R. FIGS. 4 & 5 shall be referenced to understand the detailed arrangement of the scrubbing brush assembly 204F and 204R. Both the front and rear scrubbing brush assembly 204F and 204R are identical and are assembled symmetrically. For simplicity in understanding the said scrubbing brush assembly will be henceforth labeled and referred to as scrubbing brush assembly 204. FIG. 4 shows a close-up view of the scrubbing brush assembly 204. The scrubbing brush 302 of the scrubbing brush assembly 204 is mounted coaxially with respect to the device 102. The scrubbing brush 302 is actually two half circular brush segments mounted on the freely sliding brush mount (not shown) forming a complete circular scrubbing brush 302. The sliding brush mount is secured on a plurality of guide rods 304 and also attached to a reciprocating mechanism 306, which can also be referred to as a jagging mechanism assembly. The reciprocating mechanism can be simply a crank-shaft mechanism or a Scotch-Yock mechanism or a rack and Pinion Mechanism or any other mechanism known in art to convert rotary motion to a linear motion. The mechanism 306 is driven by a motor 308. The rotation of the motor 308 moves the mechanism which translates the rotary motion into a linear motion which in-effect moves the brush mount forward and backward over the guide rods along the axis of the cleaning device 102. The speed of the reciprocating brush action (scrubbing action) can be adjusted based on the speed of the motor.

Now referring to FIGS. 3 and 4 again, the spray nozzle assembly 310F and 310R is attached next to each front and rear scrubbing brush assemblies 204F and 204R respectively. The spray nozzle assembly can be explained in more detail by referring to FIG. 6. The spray-nozzle assembly 310 comprises a spray nozzle manifold 702, a plurality of outlet spray nozzles 704 mounted radially on the spray nozzle manifold 702. The spray nozzle assembly 310 receives a cleaning liquid or a lubricating oil from external cleaning liquid reservoirs through an inlet connector 706.

Now referring to FIG. 7, the following section will describe the construction of the Encoder assembly 203. The encoder assembly 203 comprises a freely moving encoder wheel 402, an electronic rotary encode 404, and spring-loaded guide assembly 406. All of the assembly is placed in an enclosure 408. The freely moving encoder wheel 402 is a specially designed wheel with an integrated fine gear which transfers the motion to the high-resolution electronic rotary encoder 404 via a gear mechanism with no or negligible backlash. The external surface of the encoder wheel 402 is constantly making firm contact with barrel surface through a spring-loaded guide assembly 406. When the device 102, crawls inside the gun barrel, the encoder wheel 402 smoothly rolls over the barrel surface without slippage; this motion is transferred to the electronic rotary encoder which is able to measure smallest motion of the device with heigh precision and provide the linear displacement measurement and device position along the linear axis of the gun barrel. The role of the Encoder assembly is to measure the linear displacement of the device along with the barrel axis.

Now the following section will describe the construction of the Mopping Brush assembly 206. The Mopping brush assembly can be well understood when read along with FIGS. 8, 9 and 10. Referring to FIGS. 8 and 9, the brush assembly comprises a plurality of brush units 502 that are radially opened or closed as per need with respect to the axis of device 102. The brush units are mounted in a plurality of sliding slots of a brush segment mounting hub 507, wherein the brush segment mounting hub 507 is attached on a hollow central shaft 508, to which a slotted disk cam 504 is attached on a support bearing 506. The brush segment mounting hub 507 and the slotted disk cams 504 are mounted on tie-rods (not shown) which hold the entire assembly in place with respect to the device 102 liner axis. The brush units 502 are attached to the brush segment mounting hub 507 by means of a plurality of slider pins and a plurality of guiding pins (not shown) engaged into the slotted disk cam 504. The brush unit opens or closes by sliding motion of a brush unit 502, with respect to the direction of rotation of the slotted disk cam 504. For example, when the slotted disc cam 504 rotates clockwise, the brush units slide radially outward to open and when the slotted disc cams 504 rotate counterclockwise the brush units radially slide inward to close. The rotation of the disc cam is achieved by rotating the hollow shaft 508, driven by a brush actuation motor 512 and a mopping mechanism assembly 510. Thus, during a mopping operation the brush assembly expands radially by moving the slotted disk cam 504 clock-wise which in turn moves the brush segments radially outward.

During the mopping operation, the mopping brush is covered by a disposable lint free stretchable cloth cap 602 as can be seen in FIG. 10, wherein the lint free stretchable cloth cap 602 can be easily attached or detached with the help of an elastic band provided at the rim (not shown). The lint free stretchable cloth cap 602 can be made up of any oil or liquid absorbing material that is stretchable. Due to its elastic properties, the cap 602 can take the shape of the brush whether it is open or closed.

The entire cleaning operation is divided in three steps viz, scrubbing, mopping, and lubrication. The first step of cleaning is scrubbing. For this the cleaning solution is sprayed radially inside the barrel surface by means of the spray nozzle assembly 310F and 310R. The cleaning liquid is pumped from a Pump Unit 108 in FIG. 1 from cleaning liquid reservoir 1002, as shown in FIG. 13, via the main composite cable harness 106 with the tubing that carries the cleaning liquid to the device 102 controlled by a pump from where it is further fed to the spray nozzle manifold 702 via the inlet connector 706. A pressurized cleaning liquid is then sprayed over the entire inner wall of the barrel through plurality of spray nozzles 704. The cleaning liquid reacts with the combustion residue, carbon, copper and other undesirable material and unbinds it from the barrel surface. The sludge thus produced can now be easily scrubbed out by a reciprocating action of brush assembly 204F and 204R. The scrubbing action involves linear reciprocating push and pull action (along the longitudinal axis of the cylindrical object) at a high frequency as can be seen in FIG. 5. In FIG. 5 the scrubbing brush 302 is moved forward and backward at a high frequency. The complete forward and backward strokes are achieved by one complete rotation of the scrubbing mechanism 306, driven by a motor 308. The speed of scrubbing can be controlled programmatically as per requirement.

The next step of cleaning is mopping, which is achieved by the mopping brush assembly 206. During the mopping operation the mopping brush segments 502 along with the stretchable cloth cap 602 radially expands and create a tight seal by pressing it against the inner wall of gun barrel. This expansion is carried out when the device reaches the chamber section of the gun barrel which usually has a larger diameter than the actual gun barrel. When device 102 starts crawling back towards the muzzle end of the gun barrel, the tight seal of mopping brush mops and wipes the debris from the gun barrel surface and fetch it out along with the mopping cloth 602.

The last stage of the cleaning is lubrication. Similar to cleaning liquid spray, the gun lubricant oil is pumped from a Pump Unit 108 in FIG. 1 from Lubricant oil reservoir 1004, as shown in FIG. 13 via the main composite cable harness 106 with the tubing that carries the lubricant oil to the device 102 controlled by a pump from where it is further fed to the spray nozzle manifold 702 via the inlet connector 706. A pressurized lubricant oil is then sprayed over the entire inner wall of the barrel through plurality of spray nozzles 704.

The drive assembly 202 is located towards the middle of the device 102. This arrangement facilitates cleaning the ends of the barrel without the drive assembly 202 getting disengaged from the barrel and the maximum portion of the cleaning device might be in overhanging stage. If that happens, the drive assembly 202 may not support the movement of the system inside the barrel and may pose device fall off threat. While the device 102 is cleaning at the chamber end or the muzzle end of the barrel, the scrubbing brush assemblies 204F and 204R, being located towards the longitudinal ends of the device 102 with respect to the drive assembly 202 now can effectively clean the ends of the barrel as compared to the limitations in the prior art. That is, providing the drive assembly 202 towards the middle of the device 102 can be better than providing a drive unit at one end of the device or provided at both ends of the device (for example a drive unit at one end and a separate driven unit at the other end). In this way, embodiments of the present disclosure can address shortcomings that occur for devices in which the drive unit is provided at end of the device.

There is also an advantage associated with the mopping brush assembly 206 being located just after the vision system 208 (in a longitudinal dimension from the front to the back of the device 102) in that the mopping brush assembly 206 removes the debris and in the process mops/wipes the surface for the vision system 208 for inspection as it moves towards the open end of the barrel.

Now referring to FIGS. 1, 11, and 12, the following section will describe the construction of an embodiment of the camera-based vision system 208. In one embodiment, the vision system 208 is configured for capturing 360° view images and real time video footage of the inner wall of the straight hollow cylindrical object (gun barrel). The vision system 208 is attached to the front end of device 102.

There are several possible ways of providing an integrated camara based inspection for the proposed cleaning and inspection device 102. The following section provides the details of two such embodiments.

In one of the embodiments a rotary camera module 208-A is proposed. FIG. 11 shows an illustration of the rotary camera module 208-A. The rotary camera module 208-A essentially comprises of two sub-assemblies, a stationary (Nonrotating) part 802 and a rotary camera head 804. The stationary part 802 of the rotary camera module 208-A, is attached to the cleaning and inspection device 102, next to the mopping brush assembly. The stationary part 802 essentially provides a means of physical mounting of a camera unit as well as providing power and a data interface through a slip ring with the main controller 104. It also acts as an enclosure for a stationary internal gear 806 and bearing housing (not shown) which is rotatably connected to a rotary camera head 804. The rotary camera head 804 is the rotary part driven by the rotary head drive motor 808. The rotary camera head 804 is rotatably coupled with the stationary part through a bearing housing and a gear mechanism. The rotary camera head 804 as seen in FIG. 11 is a cylindrical cup shaped part. The rotary camera head 804 is fitted with an image sensing device 810 pointing towards the inner wall, a linear distance sensor 814, an angular sensor (not shown) and an electronic board (not shown). The electronic board is configured to receive signals from the image sensing device 810, the linear distance sensor 814 and the angular sensor, and communicate the received data to the main controller unit 106 in a wired mode or a wireless mode.

In an embodiment, the linear distance sensor 814 is any one selected from a laser range finder and a linear encoder. The linear distance sensor 814 is secured at the front end of the rotary camera head 804 pointing towards the chamber end of the straight hollow cylindrical object, and configured to detect the distance thereof, from the reference point. In this way, the linear distance sensor 814 is used for measuring a distance between the vision system 208-A and an end of the cylinder. In the embodiment where the linear distance sensor 814 is a laser range finder, the chamber end of the gun barrel is temporarily closed while the cleaning device 102 is in operation. The image sensing device 810 is a high resolution camera sensor with a wide angle lens. The image sensing device 810 pointing towards the inner wall is configured to capture images of the inner wall surface while the angular sensor is configured to sense the radial direction of the image sensing device view. That is, the angular sensor is for measuring an angular orientation of the vision system 208-A, about the longitudinal axis of the cylindrical object, relative to a reference orientation within the cylindrical object. The reference orientation may be any point around the circumference of the cylindrical object that provides a reference point against which the angular orientation of the vision system 208-A within the cylindrical object can be defined. In an embodiment, the angular sensor is selected from a gyro sensor and a rotary encoder. The rotary camera head 804 is fitted with LED lights 812 with light diffusers (not shown). The light emitted from the LEDs 812 is diffused by the angled diffuser in order to uniformly illuminate the internal surface of straight hollow cylindrical object/barrel section avoiding glare.

The rotary head drive 804 houses a motor 808. The motor 808 is connected to the rotary camera head 804 through a gear arrangement for rotating the rotary head 804 about the longitudinal axis of the cleaning device 102. In this example, the angular sensor is for measuring an angular orientation of the rotary head 804 of the vision system 208-A, about the longitudinal axis of the cylindrical object

Data, which includes the distance data received from the linear distance sensor 814, the angle data received from the angular sensor, and image data received from the image sensing device 810, is transmitted to the main controller unit 104. More particularly, the distance data and angle data are associated with each captured image that is represented by the image data. In this way, the location and orientation of the camera within the cylindrical object, at the time that the image data was captured, is stored in association with the image data. This enables the individually captured images (as represented by the image data) to be stitched together to provide an overall image of the entire inner surface of the cylindrical object if required. Additionally, it can enable the exact radial viewing angle and longitudinal position of Rotating camera module 208-A to be determined. This feature provides an interactive and accurate position of the camera view for the inspection of the inner surface of the hollow cylindrical object for mapping of defects. In one example, a defect can be automatically detected in the image data (for instance using a known object recognition algorithm), and then the single output could be determined for that detected defect based on the distance and angle data that is associated with the image data in which the defect was detected. The captured images along with the position data allow the inspection party to re-inspect the area of interest without any difficulty.

In one of the embodiments a multi camera module 208-B is proposed. FIG. 12, shall be referenced to understand the detailed arrangement of this embodiment of the muti-camera based vision system 208-B. In this embodiment, the muti-camera based vision system 208-B is a multi-camera unit configured for capturing 360° view images and real time video footage of the inner wall of the straight hollow cylindrical object (gun barrel). The muti-camera based vision system 208-B is attached to the front end of device 102. The muti-camera based vision system 208-B comprises a camera hub 904, a linear distance sensor 908, an angular sensor (not shown), and an image processing module 912 housed in a multi camera module enclosure 902. The camera hub 904 is fitted with a multiple number of image sensing devices 906 pointing radially towards the inner wall, the linear distance sensor 908, and the angular sensor (not shown). Each image sensing device 906 has a field of view covering a section of the perimeter of the straight hollow cylindrical object. In an embodiment, the camera hub 904 is fitted with multiple image sensing devices 906 having wide-angle field of views, with each image sensing device 906 covering at least one quadrant of the inner perimeter of the straight hollow cylindrical object.

The linear distance sensor 908 may be implemented in the same way as that described with reference to FIG. 11 above. In an embodiment, the linear distance sensor 908 is any one selected from a laser range finder and a linear encoder. A chamber end at a front side of the straight hollow cylindrical object being the reference point, the linear distance sensor 908 pointing towards the chamber end of the straight hollow cylindrical object, is configured to detect the distance thereof, from the reference point. In the embodiment when the linear distance sensor is a laser range finder, the chamber end of the gun barrel is temporarily closed while the cleaning device 102 is in operation, for the laser to revert back with the distance. The laser range finder is fitted at the front end of the cleaning device.

In a similar way to that described with reference to FIG. 11 above, the angular sensor is for measuring an angular orientation of the vision system 208-B, about the longitudinal axis of the cylindrical object, relative to a reference orientation within the cylindrical object. In this example, each of the plurality of image sensing devices 906 is fixedly connected to a camera hub 904 such that each of the plurality of image sensing devices 906 has a predefined and fixed angular relationship (about the axis of the cleaning device 102) with reference to the body of the cleaning device 102. Nonetheless, as discussed above, the cleaning device 102 rotates spirally about its longitudinal axis as it moves along the length of the cylindrical object. Therefore, as the cleaning device 102 moves along the cylindrical object capturing images as image data, it also records angle data for each image that represents the angular orientation of the image sensing device 208-B that captures the image data within the cylindrical object. It will be appreciated that this angle data can be calculated by determining the angular orientation of the cleaning device 102 within the cylindrical object based on an output signal from the angular sensor and then, if necessary, adding a predefined angular offset to the output signal, wherein a different predefined angular offset is associated with each of the individual image sensing devices 906 based on their known (fixed) orientation within the cleaning device 102.

The image processing module 912 is arranged inside the cylindrical casing 902 and configured to receive data from the multiple number of image sensing devices 906, the angular sensor and the linear distance sensor 908, and to process the received data into a single image depicting 360° view of the inner wall. This can be performed by stitching together the image data from each of the image sensing devices 906, using the associated distance and angle data to determine how they should be stitched together to provide an overall image of the entire inner surface of the cylindrical object if required. In an embodiment, the image processing module 912 consists of a signal processing module selected from a field programmable gate arrays (FPGA) and a microcontroller/microprocessor-based compute module. The image processing module 912 is configured to provide real time image processing, image stitching, image fusion and configured to communicate image/video data with the controller unit 104 in real time.

All the cleaning steps and the cleaning speed can be programmatically set with the help of the main control unit 104 in FIG. 1. In an embodiment, the cleaning device 102 is connected to the main controller unit 104 with a main cable harness 106 also the pump unit 108 comprising fluid storage tanks 1002, and 1004 respectively fitted with level indicator, pressure gauge and pump motors connected with the main controller 104 with pump cable (not shown) and the Cleaning and Inspection device 102 through the main composite cable harness 106 with tubing that carries cleaning fluid and lubricants.

FIG. 13 shows a general set-up of Pump Unit 108. The Pump Unit 108 comprises of a cleaning liquid reservoir 1002, a lubricant oil reservoir 1004, inlet ports for cleaning liquid and lubricant oil 1006, a pump and motor assembly 1008, outlet ports for cleaning liquid and lubricant oil 1010 and a battery unit 1012. Both the reservoirs 1002 and 1004 are fitted with a liquid level indicator and sensor. (not shown). The pump unit is operably connected with the controller for switching ON and OFF. The output ports for cleaning liquid and lubricant oil 1010 are operably connected with cleaning and inspection device 102 to the interface unit 210 via a composite main cable 106 with tubing.

The overall set-up of the complete cleaning and inspection system 100 be understood by referencing FIG. 14 that depicts the system architecture,

The main controller is powered either by an AC supply or DC power supply through a portable battery or directly from the carrier vehicle of the gun system. The main computer comprises a central processing unit and a graphical processing unit and a memory storage device. The main computer provides a means of command and control of the device 102. A display screen mounted on the main control unit provides a means of graphical user interface to select the switching ON and OFF, speed controlling and overall programming of the cleaning and inspection operations of the device.

The images captured by the vision system 208 are stored in a memory of the main computer and are used for image processing and image analysis to detect cleaned and uncleaned areas of inner wall of barrel or to identify any surface defects, localize the defect in the barrel and label it with the use of deep learning neural network based image processing algorithms, processed by the graphical processing unit and the central processing unit. The computational neural network based deep leaning model is trained with a set of image data comprising cleaned and uncleaned images of the inner wall of the barrel and also sample images of erosion, wear, and surface defects on the inner wall of the barrel. The trained models provides the means for comparison of cleaned and uncleaned areas of inner wall of barrel and is also able to detect, identify and localize the surface defects present on the inner wall of barrel.

In some embodiments, the image processing module implements one or more machine learning models trained to analyze image data of internal bore surfaces. The machine learning model may comprise a convolutional neural network (CNN), a segmentation model, or a classification model trained using labeled training data that includes images of clean surfaces, unclean surfaces, and surfaces exhibiting defects such as erosion, wear, cracks, or deposits.

The training data may include images annotated with pixel-level labels or region-level labels identifying areas of interest. The model may be trained using supervised learning techniques to output one or more of: (i) a classification of surface condition, (ii) a segmentation map identifying regions of contamination or defects, and (iii) coordinates of detected regions relative to longitudinal and angular position.

During operation, the trained model receives image data along with associated distance and angular orientation data and outputs location-specific information identifying regions requiring additional cleaning or inspection.

The model may be executed on a processor within the image processing module or on the main controller unit.

In a preferred embodiment, the overall automatic cleaning and inspection process flow of the device is explained in conjunction with FIG. 15. Referring to FIG. 15, the inspection and cleaning operation of the device commences by inserting the device into the gun barrel bore from muzzle end. Once inserted into the barrel and connected to the main control unit 104, the device 102, using a main control cable 106, and pump unit 108 and powered on the main controller, automatically starts with a trigger of a proximity senor (not shown).

The first cycle of the device 102 rolling inside the barrel is to acquire a plurality of images of the inner wall of the barrel by the vision system 208 at a plurality of sections travelled by the device 102, inside the barrel; and simultaneous spraying of cleaning liquid radially on the inner wall of the barrel. The images acquired before cleaning are stored in the memory of the main computer.

Next there are pre-defined passes of wet scrubbing along with cleaning liquid spray of the entire inner wall of the barrel to ensure detachment of sludge and removal of combustion residue and other undesirable material from the inner wall of the barrel.

The final pass is for mopping of loose sludge, wipe the surface fully clean and dry the barrel inner wall followed by image acquisition after cleaning and finally lubricating the barrel to protect it from corrosion.

The pre-cleaning and post-cleaning images are then analyzed and processed, and the computation of cleaning performance is derived using deep learning and image processing models.

In case where the image processing detects any uncleaned patch with its localized coordinates (for example as determined from the distance data and angle data that are described above), as can be seen in FIG. 17, the system intelligently generates a selective cleaning sequence to clean the uncleaned patches inside the barrel. Thus, the entire cleaning operation is governed by a closed loop control system. The system stores completely traceable data of images as shown in FIG. 17, raw images captured before and after cleaning, labeled images of uncleaned patches detected by an AI model with the liner and radial positions and finally, final post-cleaning image data for future assessment of gun barrel condition.

The program then can generate the entire report of the cleaning operation and provide traceable evidence and cleaning status of the barrel and also indicate the presence of any anomaly on the inner wall of the barrel.

The time-stamped cleaning data also helps in monitoring the condition of the gun barrel to estimate quality and effective service life of the gun barrel.

FIG. 16 indicates a Graphical User interface of the main controller where the user can choose to operate the system in fully automatic mode or with a manual mode. In fully automatic mode a preprogrammed sequence of inspection and cleaning is performed automatically, whereas in manual mode the user needs to select various options for different operations and various controls provided on the keypad and graphical user interface menus. In FIG. 16, in the GUI a real time camera view is seen with a clear indication of the camera view linear and radial position in automatic cleaning and inspection mode. The GUI also provides the health status of the system, status of correct insertion of cleaning device inside the gun barrel, battery level, indication of the fluid levels, memory capacity and many other such useful functions. It also allows users to view historical time stamped data of cleaning and inspection performed previously, that are stored with a unique reference identifier.

### Advantages of the Invention

The foregoing descriptions of specific embodiments of the present invention have been presented for purposes of illustration and description. They are not intended to be exhaustive or to limit the present invention to the precise forms disclosed, and it will be appreciated that many modifications and variations are possible in light of the above teaching. The embodiments were chosen and described in order to best explain the principles of the present invention and its practical application, and to thereby enable others skilled in the art to best utilize the present invention and various embodiments with various modifications as suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

We claim:

1. A system (100) for cleaning and inspecting straight hollow cylindrical objects, the system (100) comprising a robotic cleaning and inspection device (102) connected to a main controller unit (104); the robotic cleaning and inspection device (102) comprising:
a drive assembly (202) comprising at least one motor and a plurality of wheels configured to move the robotic cleaning and inspection device (102) linearly along the length of the straight hollow cylindrical object while rotating the robotic cleaning and inspection device spirally on its longitudinal axis;
a spray nozzle assembly (310F, 310R) connectable to a source of cleaning fluid, operably connected to the main controller unit (104), the spray nozzle assembly (310F, 310R) having outlet spray nozzles (704);
a vision system (208) attached to the front end of the cleaning device (102) and operably connected to the main controller unit (106), the vision system (208) configured for capturing images and real time video footage of the inner wall of the straight hollow cylindrical object;
a scrubbing assembly (204F, 204R), comprising at least one scrubbing brush (302) and a reciprocating mechanism (306) comprising a motor-driven mechanical linkage, wherein the reciprocating mechanism (306) is configured to move the scrubbing brush (302) forward and backward along the axis of the cleaning and inspection device (102); and
a mopping assembly (206) comprising a plurality of radially movable mopping elements located towards the front end of the cleaning and inspection device (102) configured to selectively engage the internal bore surface;
wherein
the vision system (208) configured to capture image data corresponding to full circumferential (360°) view images and real time video footage of the inner wall of the straight hollow cylindrical object, and the vision system (208) comprises:
at least one image sensing device (810, 906) pointing towards the inner wall of the straight hollow cylindrical object when in use, a linear distance sensor (814, 908) for measuring a distance between the vision system (208) and an end of the straight hollow cylindrical object when in use, an angular sensor for measuring an angular orientation of the vision system (208) about a longitudinal axis of the straight hollow cylindrical object when in use, relative to a reference orientation within the straight hollow cylindrical object; and
an image processing module (912), the image processing module (912) comprising at least one processor configured to receive data from the at least one image sensing device (810, 906), the linear distance sensor (814, 908), and the angular sensor, and configured to process the received data into a single image depicting a 360° view of the inner wall of the straight hollow cylindrical object.

2. The system (100) of claim 1, wherein the drive assembly (202) is located at a mid-section of the cleaning and inspection device (102).

3. The system (100) of claim 1 or claim 2, wherein the scrubbing unit assembly comprises:
a front scrubbing brush assembly (204F), which includes a scrubbing brush (302) and a reciprocating mechanism (306), wherein the reciprocating mechanism (306) is configured to move the scrubbing brush (302) forward and backward along the axis of the cleaning and inspection device (102); and
a rear scrubbing brush assembly (204R), which includes a scrubbing brush (302) and a reciprocating mechanism (306), wherein the reciprocating mechanism (306) is configured to move the scrubbing brush (302) forward and backward along the axis of the cleaning and inspection device (102);
wherein the front scrubbing brush assembly (204F) and the rear scrubbing brush assembly (204R) are located on opposite sides of the drive assembly (202).

4. The system (100) of claim 3, wherein the spray nozzle assembly comprises:
a front spray nozzle assembly (310F) operably connected to the main controller unit (104); the front spray nozzle assembly (310F) having outlet spray nozzles (704), wherein the front spray nozzle assembly (310F) is attached next to the front scrubbing brush assembly (204F); and
a rear spray nozzle assembly (310R) operably connected to the main controller unit (104); the rear spray nozzle assembly (310R) having outlet spray nozzles (704), wherein the rear spray nozzle assembly (310R) is located next to the rear scrubbing brush assembly (204R).

5. The system (100) of claim 3, wherein the mopping assembly (206) is located next to the front scrubbing brush assembly (204F).

6. The system (100) of claim 4, wherein the mopping assembly (206) is located next to the front scrubbing brush assembly (204F).

7. The system (100) of any preceding claim, wherein the vision system (208) is attached next to the mopping assembly (206) at the front end of the cleaning and inspection device (102).

8. The system (100) of any preceding claim, wherein the spray nozzle assembly (310F, 310R) includes a plurality of outlet spray nozzles (704) mounted radially on a spray nozzle manifold.

9. The system (100) of any preceding claim, wherein the linear distance sensor (814, 908) is secured at the front end of the vision system (208), such that it is configured to point towards a chamber end of the straight hollow cylindrical object when in use, and configured to detect the distance of the vision system (208) from a reference point.

10. The system (100) of any preceding claim, wherein the mopping assembly (206) comprises a plurality of mopping brush units (502), which are configured to be radially opened or closed with respect to the axis of device.

11. The system (100) of any preceding claim, wherein the vision system (208) comprises:
a rotary camera module (208-A), the rotary camera module (208-A) comprising a stationary part (802) and a rotary camera head (804), wherein the rotary camera head (804) is rotatably coupled with the stationary part (802), and wherein the rotary camera head (804) comprises the at least one image sensing device (810).

12. The system (100) of any one of claims 1 to 9, wherein the vision system (208) comprises:
a multi camera module (208-B), the multi camera module (208-B) comprising a camera hub (904) which is fitted with a plurality of image sensing devices (906) that each point radially towards the inner wall of the straight hollow cylindrical object when in use.

13. A method of using the system (100) of any preceding claim, the method comprising:
during one or more first passes of the cleaning and inspection device (102) along a straight hollow cylindrical object: acquiring pre-cleaning images of the inner wall of the straight hollow cylindrical object using the vision system (208); and spraying cleaning liquid radially on the inner wall of the straight hollow cylindrical object using the spray nozzle assembly (310F, 310R);
during one or more subsequent passes of the cleaning and inspection device (102) along the straight hollow cylindrical object, activating the reciprocating mechanism (306) of the scrubbing assembly (204F, 204R) to move the scrubbing brush (302) forward and backward along the axis of the cleaning and inspection device (102) to remove undesirable material from the inner wall of the hollow cylindrical object;
during one or more subsequent passes of the cleaning and inspection device (102) along the straight hollow cylindrical object, radially expanding the mopping assembly (206) such that a plurality of mopping brush units (502) of the mopping assembly (206) presses against the inner wall of the straight hollow cylindrical object; and
during a subsequent pass of the cleaning and inspection device (102) along the straight hollow cylindrical object, acquiring post-cleaning images of the inner wall of the straight hollow cylindrical object using the vision system (208).

14. The method of claim 13, further comprising:
spraying lubricant radially on the inner wall of the straight hollow cylindrical object using the spray nozzle assembly (310F, 310R).

15. The method of claim 13 or claim 14, further comprising:
processing the pre-cleaning images and the post-cleaning images of the inner wall of the straight hollow cylindrical object to assess cleaning performance using deep learning and image processing models.

16. The method of any one of claims 13 to 15, further comprising:
processing the pre-cleaning images and the post-cleaning images of the inner wall of the straight hollow cylindrical object to detect any uncleaned patches on the inner wall of the straight hollow cylindrical object and their associated coordinates; and
generating a further cleaning sequence for automatically controlling the cleaning and inspection device (102) such that it cleans the detected uncleaned patches.
